(19) United States
(12) Patent Application Publication
(10) Pub. No.: US 2017/0085605 A1
(43) Pub. Date: Mar. 23, 2017

(54) OBJECT-BASED TELECONFERENCING PROTOCOL

(71) Applicant: ComHear, Inc., La Jolla, CA (US)

(72) Inventor: Alan Kraemer, Irvine, CA (US)

(73) Assignee: ComHear, Inc., La Jolla, CA (US)

(21) Appl. No.: 15/123,048

(22) PCT Filed: Mar. 3, 2015
(86) PCT No.: PCT/US2015/018384

§ 371 Date: Sep. 1, 2016

Related U.S. Application Data
(60) Provisional application No. 61/947,672, filed on Mar. 4, 2014.

(51) Int. Cl. H04L 29/06; H04L 12/18; H04L 29/08

(52) U.S. Cl. CPC H04L 65/403; H04L 67/2804; H04L 12/1827; H04L 65/4015

(57) ABSTRACT

An object-based teleconferencing protocol for use in providing video and/or audio content to teleconferencing participants in a teleconferencing event is provided. The object-based teleconferencing protocol includes one or more voice packets formed from a plurality of speech signals. One or more tagged voice packets is formed from the voice packets. The tagged voice packets include a metadata packet identifier. An interleaved transmission stream is formed from the tagged voice packets. One or more systems is configured to receive the tagged voice packets. The one or more systems is further configured to allow interactive spatial configuration of the participants of the teleconferencing event.

### RELATED APPLICATIONS

This application claims the benefit of U.S. Provisional Application No. 61/947,672, filed Mar. 4, 2014, the disclosure of which is incorporated herein by reference in its entirety.

### BACKGROUND

Teleconferencing can involve both video and audio portions. While the quality of teleconferencing video has steadily improved, the audio portion of a teleconference can still be troubling. Traditional teleconferencing systems (or protocols) mix audio signals generated from all of the participants into an audio device, such as a bridge, and subsequently reflect the mixed audio signals back in a single monaural stream, with the current speaker gated out of his or her own audio signal feed. The methods employed by traditional teleconferencing systems do not allow the participants to separate the other participants in space or to manipulate their relative sound levels. Accordingly, traditional teleconferencing systems can result in confusion regarding which participant is speaking and can also provide limited intelligibility, especially when there are many participants. Further, clear signaling of intent to speak is difficult and verbal expressions of attitude towards the comments of another speaker is difficult, both of which can be important components of an in-person multi-participant teleconference. In addition, the methods employed by traditional teleconferencing systems do not allow “sidebars” among a subset of teleconference participants.

Attempts have been made to improve upon the problems discussed above by using various multi-channel schemes for a teleconference. One example of an alternative approach requires a separate communication channel for each teleconference participant. In this method, it is necessary for all of the communication channels to reach all of the teleconference participants. As a consequence, it has been found that this approach is inefficient, since a lone teleconference participant can be speaking, but all of the communication channels must remain open, thereby consuming bandwidth for the duration of the teleconference.

Other teleconferencing protocols attempt to identify the teleconference participant who is speaking. However, these teleconferencing protocols can have difficulty separating individual participants, thereby commonly resulting in instances of multiple teleconference participants speaking at the same time (commonly referred to as double talk) as the audio signals for the speaking teleconference participants are mixed to single audio signal stream.

It would be advantageous if teleconferencing protocols could be improved.

### SUMMARY

The above objectives as well as other objectives not specifically enumerated are achieved by an object-based teleconferencing protocol for use in providing video and/or audio content to teleconferencing participants in a teleconferencing event. The object-based teleconferencing protocol includes one or more voice packets formed from a plurality of speech signals. One or more tagged voice packets is formed from the voice packets. The tagged voice packets include a metadata packet identifier. An interleaved transmission stream is formed from the tagged voice packets. One or more systems is configured to receive the tagged voice packets. The one or more systems is further configured to allow interactive spatial configuration of the participants of the teleconferencing event.

The above objectives as well as other objectives not specifically enumerated are also achieved by a method for providing video and/or audio content to teleconferencing participants in a teleconferencing event. The method includes the steps of forming one or more voice packets from a plurality of speech signals, attaching a metadata packet identifier to the one or more voice packets, thereby forming tagged voice packets, forming an interleaved transmission stream from the tagged voice packets and transmitting the interleaved transmission stream to systems employed by the teleconferencing participants, the systems configured to receive the tagged voice packets and further configured to allow interactive spatial configuration of the participants of the teleconferencing event.

Various objects and advantages of the object-based teleconferencing protocol will become apparent to those skilled in the art from the following detailed description of the invention, when read in light of the accompanying drawings.

### BRIEF DESCRIPTION OF THE DRAWINGS

FIG. 1a is as schematic representation of a first embodiment of an object-based teleconferencing protocol for creating and transmitting tagged voice packets.

FIG. 1b is a schematic representation of a second embodiment of an object-based teleconferencing protocol for creating and transmitting tagged voice packets.

FIG. 2 is a schematic representation of a descriptive metadata tag as within the object-based teleconferencing protocol of FIG. 1.

FIG. 3 is a schematic representation of an interleaved transmission stream incorporating tagged voice packets with the descriptive metadata tags of FIG. 1.

FIG. 4a is a schematic representation of a display illustrating an arcuate arrangement of teleconferencing participants.

FIG. 4b is a schematic representation of a display illustrating a linear arrangement of teleconferencing participants.

FIG. 4c is a schematic representation of a display illustrating a class room arrangement of teleconferencing participants.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and the are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figure disclose an object-based teleconferencing protocol (hereafter “object-based protocol”). Generally, a first aspect of the object-based protocol involves creating descriptive metadata tags for distribution to teleconferencing participants. The term “descriptive metadata tag”, as used herein, is defined to mean data providing information about one or more aspects of the teleconference and/or teleconference participant. As one non-limiting example, the descriptive metadata tag could establish and/or maintain the identity of the speaker. A second aspect of the object-based protocol involves creating and attaching metadata packet identifiers to voice packets created when a teleconferencing participant speaks. A third aspect of the object-based protocol involves interleaving and transmitting the voice packets, with the attached metadata packet identifiers, sequentially by a bridge in such as manner as to maintain the discrete identity of each participant.

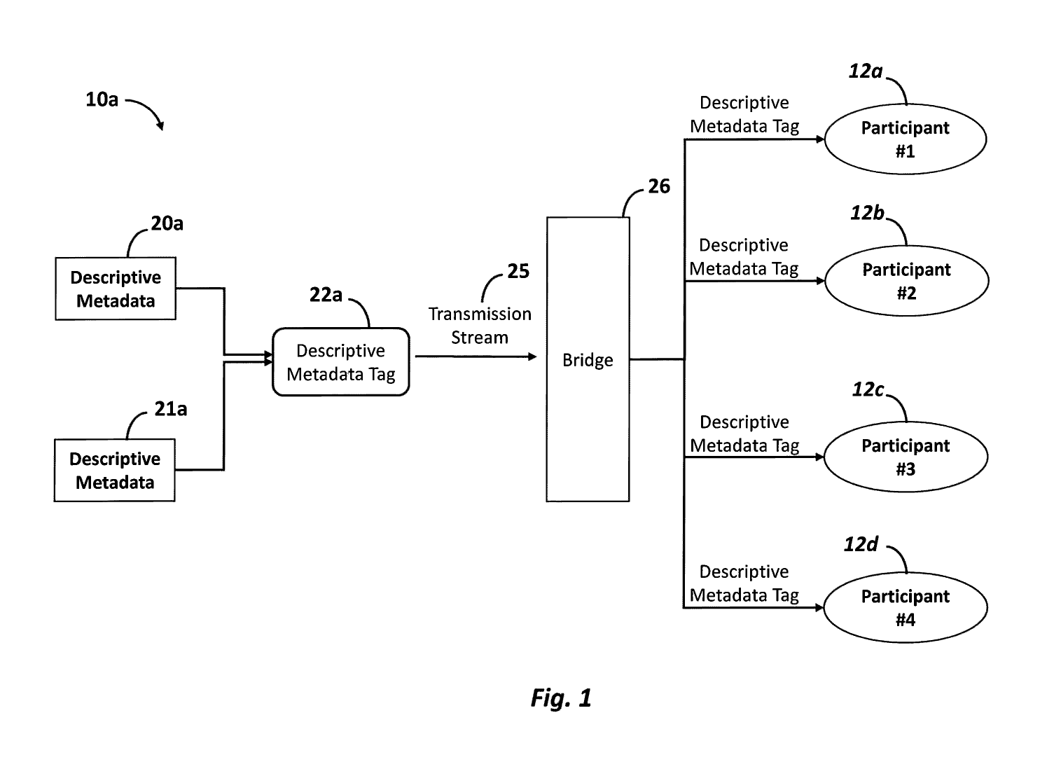

Referring now to FIG. 1, a first portion of an object-based protocol is shown generally at 10a. The first portion of the object-based protocol 10a occurs upon start-up of a teleconference or upon a change of state of an ongoing teleconference. Non-limiting example of a change in state of the teleconference include a new teleconferencing participant joining the teleconference or a current teleconference participant entering a new room.

The first portion of the object-based protocol 10a involves forming descriptive metadata elements 20a, 21a and combining the descriptive metadata elements 20a, 21a to form a descriptive metadata tag 22a. In certain embodiments, the descriptive metadata tags 22a can be formed by a system server (not shown). The system server can be configured to transmit and reflect the descriptive metadata tags 22a when a new teleconference participant joins the teleconference or there is a change in state, such as the non-limiting example of a teleconference participant entering a new room. The system server can be configured to reflect the change in state to computer systems, displays, associated hardware and software used by the teleconference participants. The system server can be further configured to maintain a copy of real time descriptive metadata tags 22a throughout the teleconference. The term “system server”, as used herein, is defined to mean any computer-based hardware and associated software used to facilitate a teleconference.

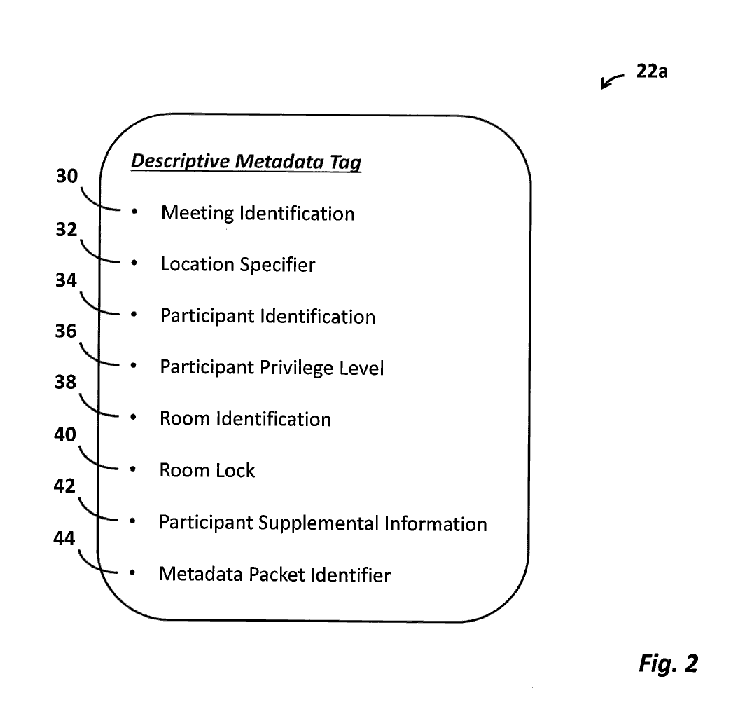

Referring now to FIG. 2, the descriptive metadata tag 22a is schematically illustrated. The descriptive metadata tag 22a can include informational elements concerning the teleconferencing participant and the specific teleconferencing event. Examples of informational elements included in the descriptive metadata tag 22a can include: a meeting identification 30 providing a global identifier for the meeting instance, a location specifier 32 configured to uniquely identify the originating location of the meeting, a participant identification 34 configured to uniquely identify individual conference participants, a participant privilege level 36 configured to specify the privilege level for each individually identifiable participant, a room identification 38 configured to identify the “virtual conference room” that the participant currently occupies (as will be discussed in more detail below, the virtual conference room is dynamic, meaning the virtual conference room can change during a teleconference), a room lock 40 configured to support locking of a virtual conference room by teleconferencing participants with appropriate privilege levels to allow a private conversation between teleconference participants without interruption. In certain embodiments, only those teleconference participants in the room at the time of locking will have access. Additional teleconference participants can be invited to the room by unlocking and then relocking. The room lock field is dynamic and can change during a conference.

Referring again to FIG. 2, further examples of informational elements included in the descriptive metadata tag 22a can include participant supplemental information 42, such as for example name, title, professional background and the like, and a metadata packet identifier 44 configured to uniquely identify the metadata packet associated with each individually identifiable participant. The metadata packet identifier 44 can be used to index into locally stored conference metadata tags as required. The metadata packet identifier 44 will be discussed in more detail below.

Referring again to FIG. 2, it is within the contemplation of the object-based protocol 10 that one or more of the informational elements 30-44 can be a mandatory inclusion of the descriptive metadata tag 22a. It is further within the contemplation of the object-based protocol 10 that the list of informational elements 30-44 shown in FIG. 2 is not an exhaustive list and that other desired informational elements can be included.

Referring again to FIG. 1, in certain instances, the metadata elements 20a, 21a can be created as teleconferencing participants subscribe to teleconferencing services. Examples of these metadata elements include participant identification 34, company 42, position 42 and the like. In other instances, the metadata elements 20a, 21a can be created by teleconferencing services as required for specific teleconferencing events. Examples of these metadata elements include teleconference identification 30, participant privilege level 36, room identification 38 and the like. In still other embodiments, the metadata elements 20a, 21a can be created at other times by other methods.

Referring again to FIG. 1, a transmission stream 25 is formed by a stream of one or more descriptive metadata tags 22a. The transmission stream 25 conveys the descriptive metadata tags 22a to a bridge 26. The bridge 26 is configured for several functions. First, the bridge 26 is configured to assign each teleconference participant a teleconference identification as the teleconference participant logs into a teleconferencing call. Second, the bridge 26 recognizes and stores the descriptive metadata for each teleconference participant. Third, the act of each teleconference participant logging into a teleconferencing call is considered a change of state, and upon any change of state, the bridge 26 is configured to transmit a copy of its current list of aggregated descriptive metadata for all of the teleconference participants to the other teleconference participants. Accordingly, each of the teleconference participant's computer-based system then maintains a local copy of the teleconference metadata that is indexed by a metadata identifier. As discussed above, a change of state can also occur if a teleconference participant changes rooms or changes privilege level during the teleconference. Fourth, the bridge 26 is configured to index the descriptive metadata elements 20a, 21a, into the information stored on each of the teleconferencing participant's computer-based system, as per the method described above.

Referring again to FIG. 1, the bridge 26 is configured to transmit the descriptive metadata tags 22a, reflecting the change of state information to each of the teleconference participants 12a-12d.

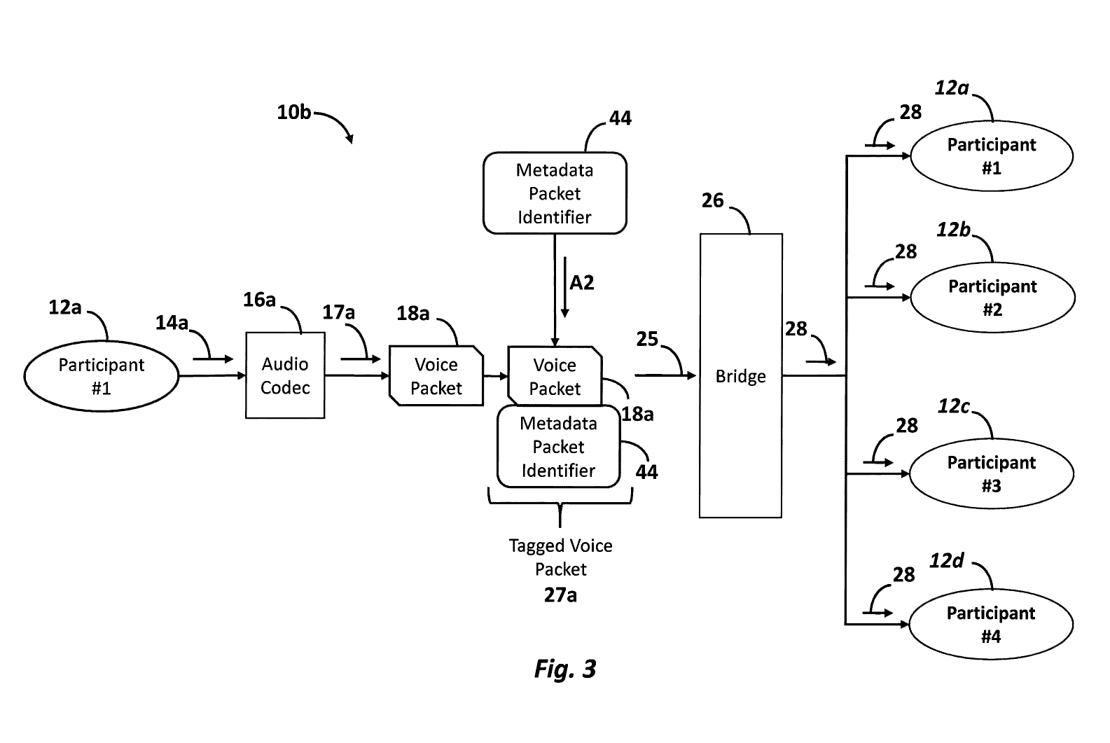

As discussed above, a second aspect of the object-based protocol is shown as 10b in FIG. 3. The second aspect 10b involves creating and attaching metadata packet identifiers to voice packets created when a teleconferencing participant 12a speaks. As the participant 12a speaks during a teleconference, the participant's speech 14a is detected by an audio codec 16a, as indicated by the direction arrow. In the illustrated embodiment, the audio codec 16a includes a voice activity detection (commonly referred to as VAD) algorithm to detect the participant's speech 14a. However, in other embodiments the audio codec 16a can use other methods to detect the participant's speech 14a.

Referring again to FIG. 3, the audio codec 16a is configured to transform the speech 14a into digital speech signals 17a. The audio codec 16a is further configured to form a compressed voice packet 18a by combining one or more digital speech signals 17a. Non-limiting examples of suitable audio codecs 16a include the G.723.1, G.726, G.728 and G.729 models, marketed by CodecPro, headquartered in Montreal, Quebec, Canada. Another non-limiting example of a suitable audio codec 16a is the Internet Low Bitrate Codec (iLBC), developed by Global IP Solutions. While the embodiment of the object-based protocol. 10b is shown in FIG. 3 and described above as utilizing an audio codec 16a, it should be appreciated that in other embodiments, other structures, mechanisms and devices can be used to transform the speech 14a into digital speech signals and form compressed voice packets 18a by combining one or more digital speech signals.

Referring again to FIG. 3, a metadata packet identifier 44 is formed and attached to the voice packet 18a, thereby forming a tagged voice packet 27a. As discussed above, the metadata packet identifier 44 is configured to uniquely identify each individually identifiable teleconference participant. The metadata packet identifier 44 can be used to index into locally stored conference descriptive metadata tags as required.

In certain embodiments, the metadata packet identifier 44 can be formed and attached to a voice packet 18a by a system server (not shown) in a manner similar to that described above. In the alternative, the metadata packet identifier 44 can be formed and attached to a voice packet 18a by other processes, components and systems.

Referring again to FIG. 3, a transmission stream 25 is formed by one or more tagged voice packets 27a. The transmission stream 25 conveys the tagged voice packets 27a to the bridge 26 in the same manner as discussed above.

Referring again to FIG. 3, the bridge 26 is configured to sequentially transmit the tagged voice packets 27a, generated by the teleconferencing participant 12a, in an interleaved manner into an interleaved transmission stream 28. The term “interleaved”, as used herein, is defined to mean the tagged voice packets 27a are inserted into the transmission stream 25 in an alternating manner, rather than being randomly mixed together. Transmitting the tagged voice packets 27a in an interleaving manner allows the tagged voice packets 27a to maintain the discrete identity of the teleconferencing participant 12a.

Referring again to FIG. 3, the interleaved transmission stream 28 is provided to the computer-based system (not shown) of the teleconferencing participants 12a-12d, that is, each of the teleconferencing participants 12a-12d receive the same audio stream having the tagged voice packets 27a arranged in a interleaved manner. However, if a teleconferencing participant's computer-based system recognizes its own metadata packet identifier 44, it ignores the tagged voice packet such that the participant does not hear his own voice.

Referring again to FIG. 3, the tagged voice packets 27a can be advantageously utilized by a teleconferencing participant to allow teleconferencing participants to have control over the teleconference presentation. Since each teleconferencing participant's tagged voice packets remain separate and discrete, the teleconferencing participant has the flexibility to individually position each teleconference participant in space on a display (not shown) incorporated by that participant's computer-based system. Advantageously, the tagged voice packets 27a do not require or anticipate any particular control or rendering method. It is within the contemplation of the object-based protocol 10a, 10b that various advanced rendering techniques can and will be applied as the tagged voice packets 27a are made available to the client.

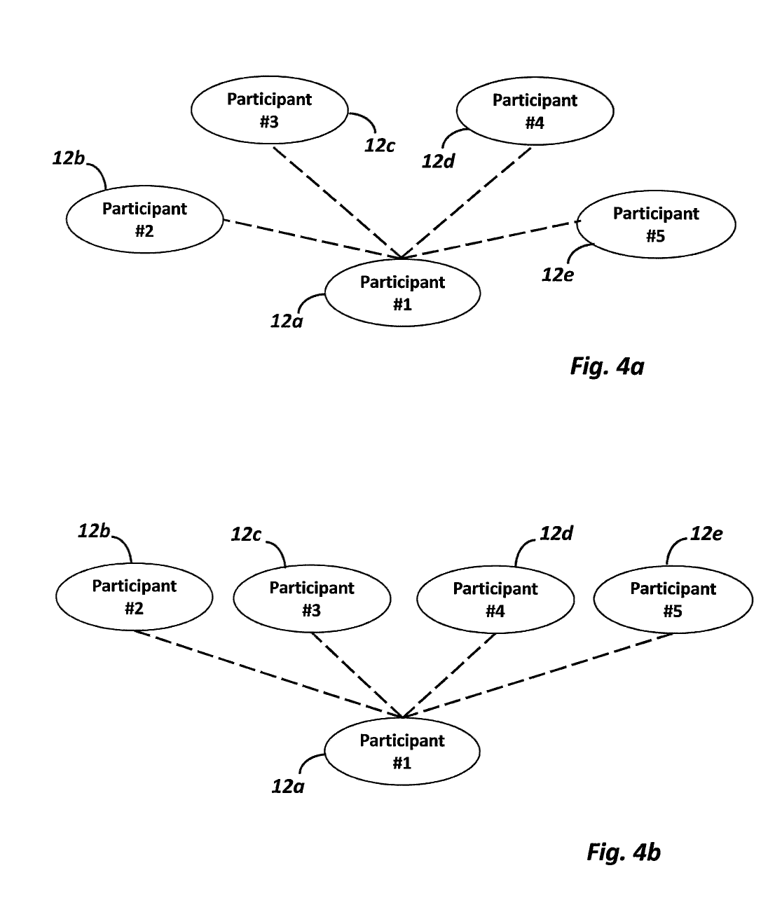

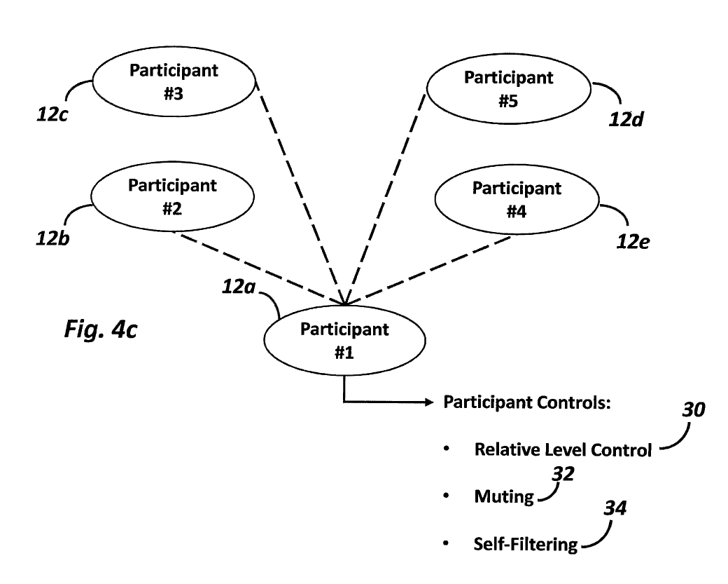

Referring now to FIGS. 4a-4c, various examples of positioning individual teleconference participants in space on the participant's display are illustrated. Referring first to FIG. 4a, teleconference participant 12a has positioned in the other teleconferencing participants 12b-12e in a relative arcuate shape. Referring now to FIG. 4b, teleconference participant 12a has positioned in the other teleconferencing participants 12b-12e in a relative lineal shape. Referring now to FIG. 4c, teleconference participant 12a has positioned in the other teleconferencing participants 12b-12e in a relative classroom seating shape. It should be appreciated that the teleconferencing participants can be positioned in any relative desired shape or in default positions. Without being held to the theory, it is believed that relative positioning of the teleconferencing participants creates a more natural teleconferencing experience.

Referring again to FIG. 4c, the teleconference participant 12a advantageously has control over additional teleconference presentation features. In addition to the positioning of the other teleconferencing participants, the teleconference participant 12a has control over the relative level control 30, muting 32 and control over the self-filtering 34 features. The relative level control 30 is configured to allow a teleconference participant to control the sound amplitude of the speaking teleconference participant, thereby allowing certain teleconference participants to be heard more or less than other teleconference participants. The muting feature 32 is configured to allow a teleconference participant to selectively mute other teleconference participants as and when desired. The muting feature 32 facilitates side-bar discussions between teleconference participants without the noise interference of the speaking teleconference participant. The self-filtering feature 34 is configured to recognize the metadata packet identifier of the activating teleconference participant, and allowing that teleconference participant to mute his own tagged voice packet such that the teleconference participant does not hear his own voice.

The object-based protocol 10a, 10b provides significant and novel modalities over known teleconferencing protocols, however, all of the advantages may not be present in all embodiments. First, object-based protocol 10a, 10b provides for interactive spatial configuration of the teleconferencing participants on the participant's display. Second, the object-based protocol 10a, 10b provides for a configurable sound amplitude of the various teleconferencing participants. Third, the object-based protocol 10 allows teleconferencing participants to have breakout discussions and sidebars in virtual “rooms”. Fourth, inclusion of background information in the tagged descriptive metadata provides helpful information to teleconferencing participants. Fifth, the object-based protocol 10a, 10b provides identification of originating teleconferencing locals and participants through spatial separation. Sixth, the object-based protocol 10a, 10b is configured to provide flexible rendering through various means such as audio beam forming, headphones, or multiple speakers placed throughout a teleconference locale.

In accordance with the provisions of the patent statutes, the principle and mode of operation of the object-based teleconferencing protocol has been explained and illustrated in its illustrated embodiments. However, it must be understood that the object-based teleconferencing protocol may be practiced otherwise than as specifically explained and illustrated without departing from its spirit or scope.

What is claimed is:

1. An object-based teleconferencing protocol for use in providing video and/or audio content to teleconferencing participants in a teleconferencing event, the object-based teleconferencing protocol comprising:
one or more voice packets formed from a plurality of speech signals;
one or more tagged voice packets formed from the voice packets, the tagged voice packets including a metadata packet identifier;
an interleaved transmission stream formed from the tagged voice packets; and
one or more systems configured to receive the tagged voice packets, the one or more systems further configured to allow interactive spatial configuration of the participants of the teleconferencing event.

2. The object-based teleconferencing protocol of claim 1, wherein the voice packets include digital speech signals.

3. The object-based teleconferencing protocol of claim 1, wherein the metadata packet identifier includes information concerning the teleconferencing participant.

4. The object-based teleconferencing protocol of claim 1, wherein the metadata packet identifier includes information concerning the teleconferencing event.

5. The object-based teleconferencing protocol of claim 1, wherein the metadata packet identifier tag includes information uniquely identifying the teleconferencing participant.

6. The object-based teleconferencing protocol of claim 1, wherein a descriptive metadata tag includes information created by a teleconferencing service configured to host the teleconferencing event.

7. The object-based teleconferencing protocol of claim 1, wherein a descriptive metadata tag includes information created for the specific teleconferencing event.

8. The object-based teleconferencing protocol of claim 1, wherein the interleaved transmission stream is formed by a bridge, configured to index the metadata packet identifier into information stored on each of the one or more systems.

9. The object-based teleconferencing protocol of claim 1, wherein the teleconferencing participants are positioned in an arcuate arrangement on a display of a participant's system.

10. The object-based teleconferencing protocol of claim 1, wherein the interactive spatial configuration of the participants provides for sidebar discussions with other participants in virtual rooms.

11. A method for providing video and/or audio content to teleconferencing participants in a teleconferencing event, the method comprising the steps of:
forming one or more voice packets from a plurality of speech signals;
attaching a metadata packet identifier to the one or more voice packets, thereby forming tagged voice packets;
forming an interleaved transmission stream from the tagged voice packets; and
transmitting the interleaved transmission stream to systems employed by the teleconferencing participants, the systems configured to receive the tagged voice packets and further configured to allow interactive spatial configuration of the participants of the teleconferencing event.

12. The method of claim 11, wherein the voice packets include digital speech signals.

13. The method of claim 11, wherein the metadata packet identifier includes information concerning the teleconferencing participant.

14. The method of claim 11, wherein the metadata packet identifier includes information concerning the teleconferencing event.

15. The method of claim 11, wherein the metadata packet identifier includes information uniquely identifying the teleconferencing participant.

16. The method of claim 11, wherein a descriptive metadata tag includes information created by a teleconferencing service configured to host the teleconferencing event.

17. The method of claim 11, wherein a descriptive metadata tag includes information created for the specific teleconferencing event.

18. The method of claim 11, wherein the interleaved transmission stream is formed by a bridge, configured to index the metadata packet identifier into information stored on each of the one or more systems.

19. The method of claim 11, wherein the teleconferencing participants are positioned in an arcuate arrangement on a display of a participant's system.

20. The method of claim 11, wherein the interactive spatial configuration of the participants provides for sidebar discussions with other participants in virtual rooms.
